(19) United States
(12) Patent Application Publication
(10) Pub. No.: US 2002/0078612 A1
(43) Pub. Date: Jun. 27, 2002

(54) Magnetic photo collage and display board

(76) Inventors: Rosemary Isabella Meacham, Oak Bluffs, MA (US); Michael Anthony Morrison, Oak Bluffs, MA (US)

Correspondence Address: Law Offices of Royal W. Craig, Suite 153, 10 North Calvert Street, Baltimore, MD, 21202, US

(21) Appl. No.: 09/996,078

(22) Filed: Nov. 28, 2001

Related U.S. Application Data
(60) Provisional application No. 60/253,411, filed on Nov. 28, 2000.

(51) Int. Cl. G09F 7/02; A47G 1/06

(52) U.S. Cl. 40/711; 40/611

(57) ABSTRACT

A decorative and practical wall mounted framing device comprising a metalized display panel of galvanized sheet metal, or other like material, sandwiched between a primary backing panel and a mitred wood or other conventional frame. Photographic prints, drawings, printed material such as documents, notes, memoranda, reminders, or the like encased in a sleeve having a transparent plastic front cover and a magnetic back surface adhere to the metalized display panel. The transparent front cover of the sleeve protects the contents from deterioration caused by exposure to the air, light, and touch. The magnetized rear surface of the sleeve enables it to be removably affixed to the metalized display panel and arranged in a collage pattern that can quickly and easily be altered by the addition or removal of prints, drawings, or printed material at the whim of the user. The framing device further comprises integral mounting brackets or wire for secure attachment to and simple removal from a wall, or is hinged to facilitate use as a freestanding unit and to enhance protability.

### CROSS-REFERENCE TO RELATED APPLICATIONS

The present application derives priority from U.S. provisional application No. 60/253,411 for “MAGNETIC PHOTO COLLAGE”; filed Nov. 28, 2000.

### BACKGROUND OF THE INVENTION

1. Field of the Invention

The present invention relates to photograph, document or other indicia display devices and, more particularly, to a magnetic photo collage framing device comprising a galvanized steel sheet, or other like material, sandwiched between a primary backing and a mitred wood or other conventional frame. Photographic prints, or other indicia, inserted into a magnetic-backed display sleeve with a transparent plastic cover, adhere to the metalized display surface and enable a movably affixed collage of prints, or other indicia, to be displayed.

2. Description of the Background

Photographs visually relate stories of experiences, people and places which have been captured on film. It is common to view such photos by manually thumbing through a stack of prints, by arranging the prints in a bound folder or photo album for display, or by framing the prints. Manually viewing, however, may damage the prints causing them to become inadvertently creased or smudged, and further makes viewing sequential or otherwise related photos difficult or awkward. Photo albums protect the prints and allow them to be arranged chronologically, by subject matter, or by any other criteria. Photo albums further allow text or tangible memorabilia associated with the photo to be displayed along-side the prints. However, viewing photos bound in an album can be cumbersome as such a display requires the turning of bulky, inflexible pages and limits the number of viewers able to see the display at the same time. Moreover, once photos have been inserted they cannot easily be removed for closer inspection or rearranged. Framing offers similar benefits of protection and creativity of layout, but usually renders the display permanent, as changing prints within the frame is made impractical by the size of the frame, the color and size of matting around the print, and difficulty of accessing the print within the closed frame.

It is known within the background art to adhere a photograph or piece of artwork encased in a sleeve having a magnetic backing and a transparent front cover to a metal surface for display U.S. Pat. No. 6,052,933 to Lytle, for example, teaches a picture framing system wherein a photograph is mounted within a pocket-type holder having a clear front surface and an adhesive or magnetic rear surface. Lytle '933 does not, however, teach a framing device within which such an encased photograph may be displayed.

U.S. Pat. No. 5,269,083 to Vampatella discloses a picture frame apparatus which features a quick change capability whereby photos having magnetized members on their back surfaces adhere to a magnetically attractive display surface. However, the fixed interior partitions or borders within the Vampatella '083 device limit the ability of the user to either creatively place the photos in a random arrangement, or vary the sizes of these photos. Instead, the user is restricted to placing the magnetized photo within one of the permanently created segments which divide the display area. Absent from the background art, therefore is a framing device which allows one to display more than one photo with a choice of sizes, in a single framing system in a variable random collage pattern which is not pre-determined by the interior structure of the device.

U.S. Pat. No. 5,384,999 to Roche teaches a multi-purpose office-style bulletin board comprising magnetically attractive screen material covering a permeable cork-board layer. The design allows the posting of office memos and reminders to be displayed either magnetically or alternatively by a push-pin or tack. The dual functionality of the bulletin board, however, renders it more bulky as it must necessarily incorporate sufficient depth for the internal corkboard, and more expensive to produce both because of the added cork-board panel and because the metallic surface must be apertured to allow a tack or push-pin to access the underlying corkboard layer. Further, the exposed areas of the bulletin board display surface present a utilitarian aspect, showing cork-board through wire-mesh, whereas the visible surface area of the present invention presents a more decorative metallic panel consistent with both the aesthetic and functional purposes of the invention, and in contrast to the predominantly utilitarian purpose of the office bulletin board in Roche '999. Finally, the smooth surface area of the magnetic display board in the present invention permits the photographic prints to lie smoothly along the same plane without the unevenness attendant to an apertured display panel.

It would be greatly advantageous to provide an improved device for displaying a series or collage of photographic prints which are intended to be viewed together by enabling photos to be magnetically attached to a framing device, whereby the photos may be quickly and easily detached for closer inspection and/or rearranged and replaced at the discretion of the user.

It would further be advantageous to provide an improved device for posting or presenting memoranda, drawings, notes, reminders and the like, whereby outdated written communications may be quickly and easily replaced with timely information.

### SUMMARY OF THE INVENTION

It is, therefore, an object of the present invention to arrange a display of photographs on a metalized sheet by magnetically attaching prints in a collage pattern.

It is another object of the present invention to encase said photographs in a sleeve comprising a transparent plastic front cover and a magnetic rear cover.

It is yet another object to mount the assembled collage of photographs on a wall for display purposes so that a series or collage of photographic prints can be viewed together by enabling photos to be magnetically attached to a framing device, whereby the photos may be quickly and easily detached for closer inspection and/or rearranged and replaced at the discretion of the user.

It is still another object to create a display device for arranging photographs in a movably affixed collage pattern said device comprising a panel of sheet metal, or other like material, sandwiched between a mitred wood or other conventional frame and a primary backing panel.

It is yet another object to create a display device for magnetically posting or presenting drawings, or written material such as memoranda, announcements, reminders and the like, said display device being adaptable for use in a home or office setting.

It is a further object to provide said framing device with brackets for mounting the device to a wall and a piano hinge for embodiments of said device which exceed a particular dimension.

According to the present invention, the above-described and other objects are accomplished by positioning a panel of galvanized sheet metal, or other like material, between a primary backing panel and a mitred wood or other conventional frame. Photographs, or other indicia, are encased in a sleeve having on one surface a transparent plastic cover and having on the reverse surface a magnetic cover. Thus bound, the rearward surface of the photographs, or other indicia, adhere to the metalized surface of the display panel. The forward surface of the photograph, or other indicia, is transparent, thereby protecting the photos, or other indicia, from damage caused from exposure to particulate matter and from oils from the touch of viewers. Optional tinting may be provided to selectively filter ultraviolet light, thereby protecting against harmful sunlight. After the photos, or other indicia, have been placed on the metalized display panel in the desired arrangement, the magnetic collage can be mounted on the surface of a wall by using the integral wall brackets which are evenly spaced along the top edge of the rear face of the primary backing panel and extend outwardly therefrom. Alternatively, the device may be mounted to a wall by suspending it from a wire securely attached at two points to the rear face of the primary backing panel. Embodiments of the framing device which exceed the dimension of 3′×4′ are preferably equipped with a piano hinge centrally positioned which extends from the bottom edge to the top edge of the primary backing panel. Thus equipped, the larger framing devices may be folded in half for portability. Alternatively, the hinged device can be a free-standing unit that is placed on a shelf or table.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a front plan view of the preferred embodiment of the magnetic photo collage and display board showing a mitred wood frame and a metal display face wherein a magnetic photo sleeve has been attached.

FIG. 2 is a back plan view of the magnetic display as in FIG. 1 showing the use of a piano hinge and the placement of wall mounting brackets.

FIG. 3 is a back plan view of the magnetic display as in FIG. 1 displaying an alternative embodiment in which the primary backing panel is without a piano hinge.

FIG. 4 is an exploded view of the magnetic display framing device first shown in FIG. 1.

### DETAILED DESCRIPTION OF THE PREFERRED EMBODIMENTS

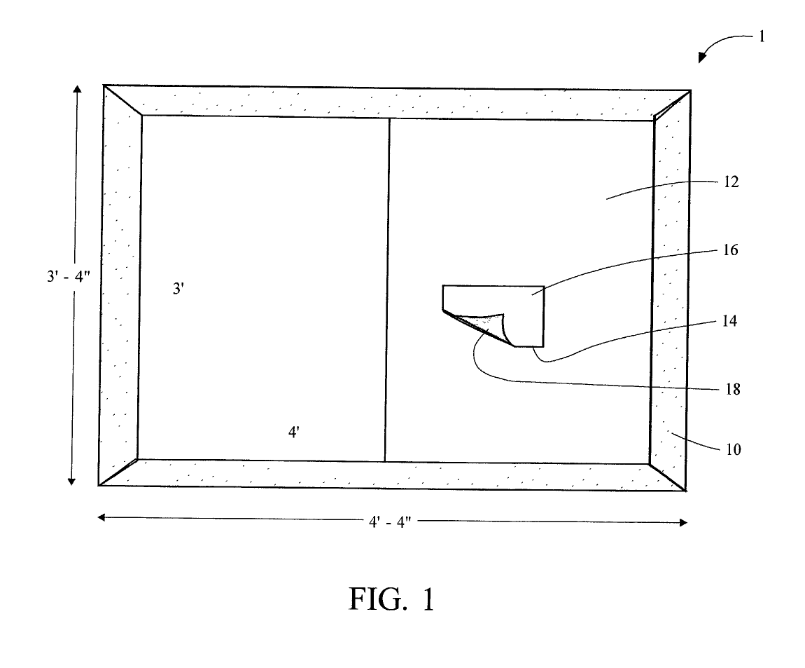

FIG. 1 is a front plan view of the preferred embodiment of the magnetic photo collage and display board 1 showing a frame 10 and a magnetic display panel 12 wherein a magnetic photo sleeve 14 has been attached. In the preferred embodiment, the frame 10 is of a wood material and circumscribes the top, bottom, left and right borders of the display 1. The frame 10 may alternatively be made of plastic, aluminum, or any other conventional frame material. The mitred frame 10 comprises four pieces joined at their terminal edges which have been cut at 45 degree angles. The frame pieces may be attached by wood screws and/or wood glue. Assembly of the frame pieces in one embodiment as shown in FIG. 1 creates a rectangular display measuring approximately 4′4″ in width×3′4″ in height. The magnetic display 12 is preferably comprised of a panel of 28 or 30 gauge galvanized sheet metal of a dimension slightly smaller than the outer edge of the frame 10 and larger than the inner edge of said frame 10 whereby the edge of the display panel 12 is concealed from view when the display unit is fully assembled.

The magnetic display 12 may alternatively be comprised of other metal material, such as light-weight board with steel particles or other steel powder coated material. The magnetic display 12 is secured in place in a sandwiched configuration by attaching a primary backing panel 20 to the mitred frame 10 by wood screws and/or wood glue. This leaves an unobstructed frontal viewing area of approximately 4′ by 3′.

Photos encased in magnetic photo sleeves 14 may be magnetically adhered to the magnetic display 12 as desired. The magnetic photo sleeve 14 comprises a transparent plastic front cover 16 heat-welded about the periphery to a magnetic rear surface 18. The magnetic rear surface 18 may be a die-cut section of MS17 Magnetic Sheeting of 0.015″ (0.4 mm) standard thickness. Such magnetic sheeting is magnetized with equally spaced poles running parallel to the length of the sheet, and it is available in gloss white. The material can be easily cut with different dies, knife, blades and scissors. The magnetic rear surface 18 is heat-welded in a known manner about the periphery to a conforming section of transparent plastic front cover 16, and the latter may be formed of translucent vinyl. If desired, the plastic front cover 16 may be tinted with conventional optical dye to limit transmission in the blue range while allowing almost complete transmission in the red range. Wavelengths less than about 490 nm can be substantially cut-off while leaving at least 70% usable light transmission. This protects the photos from the deteriorating effects of sunlight. Photographs, or other indicia, encased within the plastic sleeves 14 may be arranged on the display face at the discretion of the user, and addition and removal of photos may be quickly and easily accomplished.

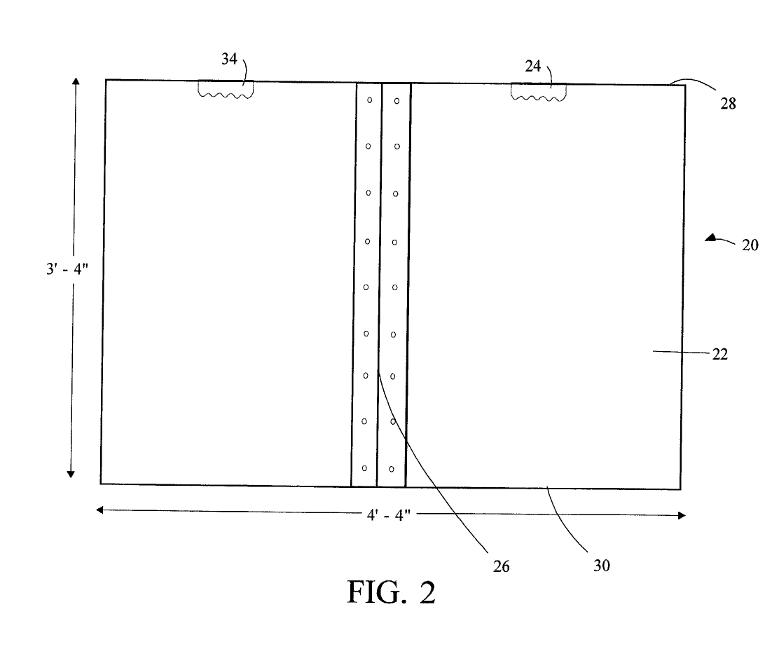

FIG. 2 is a back plan view of the magnetic photo collage and display board as in FIG. 1. The primary backing panel 20 comprises the same dimensions as the mitred frame 10 as shown in FIG. 1. The primary backing panel 20 comprises a front surface (obscured in FIG. 2) and a rear surface 22, the entirety of the panel being of a uniform particle-board composition and of a thickness of approximately ⅛″. The primary backing panel may alternately be made of cardboard, plywood, or any other lightweight and inexpensive material. The backing panel 20 is hidden when the device is displayed, and is present merely to provide a rear surface against which to position the magnetic display panel. Wall mounting brackets 24 extend outwardly from the top border of the rear surface 22 of the backing panel 20. In one embodiment, wall mounting brackets 24 may be two conventional picture brackets that are evenly spaced along the top periphery, said brackets allowing a level placement to be easily attained when the device is hung on a wall or other suitable vertical surface. The brackets 24 comprise a generally rectangular shape with downwardly disposed teeth 34. The brackets 24 may be glued, clamped, screwed or otherwise securely attached to the rear backing panel 20. The downwardly disposed teeth 34 securely grasp a nail or hook projecting from a wall. In an alternative embodiment, the device may be mounted by attaching a wire or string between the mounting brackets 24, or by otherwise securely attaching said wire or string at two points to the rear of the device. Alternatively, the magnetic photo collage and display board may be a free standing unit that may be placed on a table or shelf.

It should be apparent that the above-described dimensions may vary. Preferably, a piano hinge 26 is built into devices which exceed dimensions of 4′×3′. In such an embodiment, as shown in FIG. 2, the hinge 26 may be disposed vertically from the top border 28 of the backing panel 20 to the bottom border 30 of the panel. The piano hinge 26, a thin metal material attached to the rear panel 20 by screws, enables the device to be folded in half thereby simplifying the process of transporting the display device.

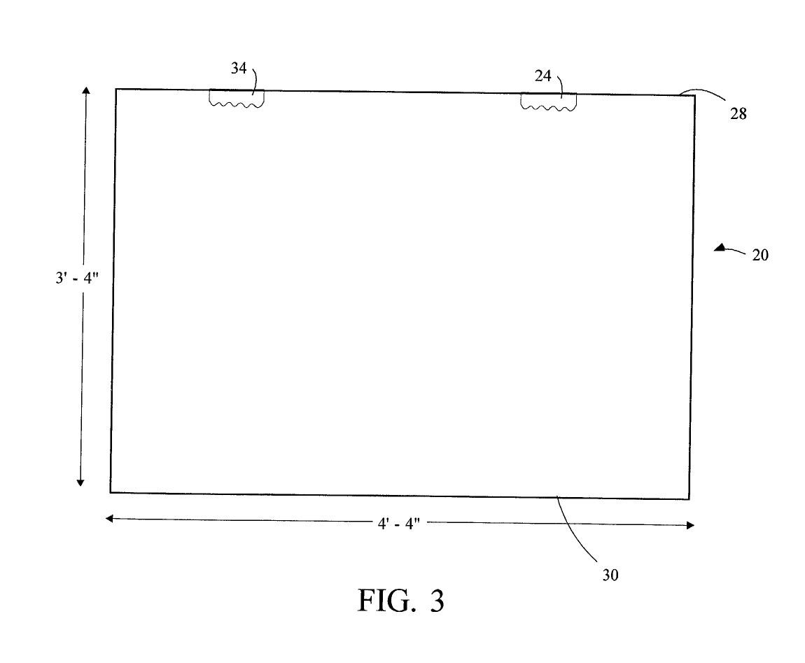

FIG. 3 is a back plan view of the magnetic photo collage and display board as in FIG. 1 displaying an alternative embodiment in which the primary backing panel 20 is without a piano hinge 26 as shown in FIG. 2. FIG. 3 again shows the placement of the wall mounting brackets 24 comprising downwardly disposed teeth 34 and positioned along the top border 28 of the rear backing panel 20.

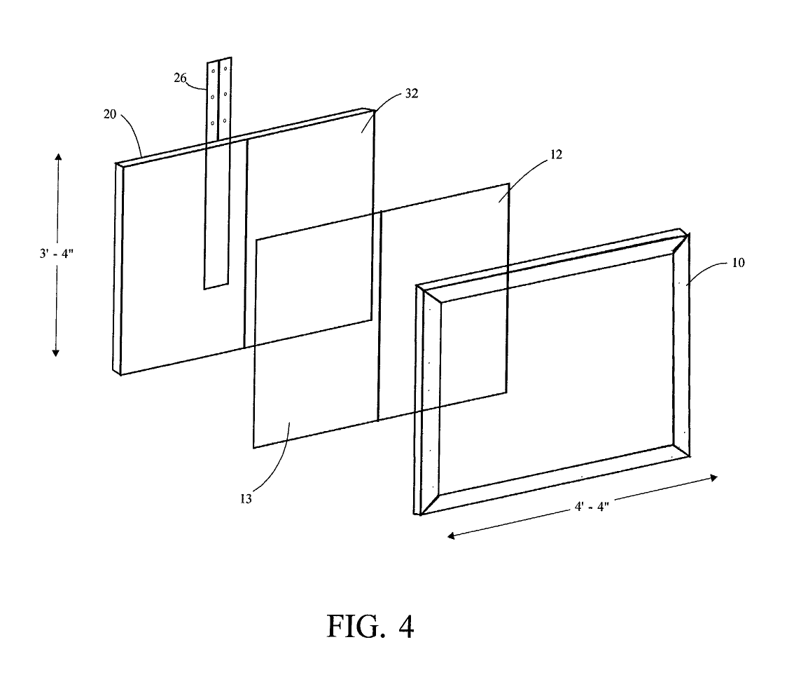

FIG. 4 is an exploded view of the magnetic photo collage and display board framing device first shown in FIG. 1. Visible in this view is the front surface 32 of the rear backing panel 20 as shown in FIGS. 2 and 3. A piano hinge 26 has been extended upwardly from its vertical placement along the rear surface of the backing panel for purposes of illustration. The magnetic display panel 12 is shown forward of the rear backing panel 20 and rearward of the mitred frame 10. The display face 13 of the magnetic display panel 12 is shown facing outwardly as in the final assembled state.

The exploded view of FIG. 4 shows that the magnetic display panel 12 attaches to the front surface 32 of the rear backing panel 20. The display panel 12 may be clipped, glued, tacked or otherwise permanently bound to the rear backing panel 20. The frame 10 may then be secured to the outer border of the rear panel 20 by any of the above means of attachment. The frame 10 forms a decorative border around the periphery of the fully assembled device and conceals the overlap created by attaching the display panel 12 to the front surface 32 of the rear panel 20.

The magnetic photo collage and display board 1 constructed in accordance with the above specifications allows the mounting of an assembled collage of photographs, or other indicia, on a wall or table for display purposes so that a series or collage of photographic prints, or other indicia, can viewed together, and yet photos, or other indicia, can be magnetically attached to a framing device for quick and easy detachment for closer inspection and/or rearranging and replacement at the discretion of the user. In addition to displaying photographs, the device can further be used for posting or presenting material such as drawings, or written material such as documents, memoranda, announcements, reminders and the like in a home or office setting. Used in this bulletin-board or display-board capacity, the display device offers a large, attractive surface to magnetically adhere such communications.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims:

We claim:

1. A framing device for displaying photographic prints, information, or other indicia comprising:
a frame;
a primary backing panel attached to said frame;
a metalized display panel secured between said frame and primary backing panel; and
a plurality of magnetized plastic sleeves each comprising a transparent front cover and a magnetic rear cover bonded together about their periphery, said sleeves being open at one end for insertion of any one from among the group comprising photographic print, notes, memoranda, and reminders;
whereby each of said photographic print, notes, memoranda, and reminders, when encased in one of said sleeves, may be adhered to said metalized panel creating an artistic display within said framing device.

2. The framing device according to claim 1, wherein said metalized display panel has an exposed frontal surface.

3. The framing device according to claim 1, further comprising two rectangular metal mounting brackets with downwardly disposed teeth, said brackets being evenly spaced along the top rear border of said panel, thereby enabling the framing device to be hung on a wall for purpose of display.

4. The framing device according to claim 1, further comprising a hanging wire securely attached at two points to the top rear border of said panel, thereby enabling the framing device to be hung on a wall for purpose of display.

5. The framing device according to claim 1, wherein said mitred wood frame has inner and outer dimensions, and the dimensions of said backing panel conform to the outer dimensions of said mitred wood frame, and dimensions of said display panel are greater than the inner dimensions of said frame but less than the outer dimensions of said frame, said metalized display panel being sandwiched between said mitred wood frame and said primary backing panel, whereby the borders of said display panel are hidden from view in said sandwiched configuration.

6. The framing device according to claim 1, wherein said primary backing panel further comprises a central piano hinge vertically disposed from the top edge of said panel to the bottom edge of said panel, whereby said framing device may be folded in half for ease of transport and to allow its use as a free-standing unit.

7. The framing device according to claim 1, wherein said metalized display panel is comprised of a galvanized steel sheet, or other like material.

8. The framing device according to claim 1, wherein said metalized display panel is comprised of light-weight board with steel particles or other steel powder-coated material.

9. The framing device according to claim 1, wherein said frame is comprised of mitred wood.

10. The framing device according to claim 1, wherein said frame is comprised of plastic or aluminum, or other conventional frame material.

11. The framing device according to claim 1, wherein said framing device may be used as a free-standing unit that sits atop a table or shelf.
